(19) United States
(12) Patent Application Publication
(10) Pub. No.: US 2003/0100199 A1
(43) Pub. Date: May 29, 2003

(54) Computer bus connector

(76) Inventor: Pai-Chuan Wang, Taipei City (TW)

Correspondence Address: Pai-Chuan WANG, PO Box 82-144, TAIPEI, TW

(21) Appl. No.: 09/991,677

(22) Filed: Nov. 26, 2001

(51) Int. Cl. H01R 12/00

(52) U.S. Cl. 439/66

(57) ABSTRACT

A computer bus connector includes a connector body, a securing plate, a plurality of signal terminals (pins), a signal wire unit and an upper cover. The computer bus connector including the above components is different from the process of making the conventional piercing type bus connector in the application of tin solder. Signal terminals and signal wires are inserted and pressed into the securing plate, and the terminals and lead wires are integrally coupled by soldering so that signal is more stable during transmission, impedance is reduced, and transmission efficiency is enhanced.

### BACKGROUND OF THE INVENTION

1. Field of the Invention

This invention is related to a computer bus connector and in particular to one comprising a connector body, a securing plate, a plurality of signal terminals (pins), a signal wire unit and an upper cover, wherein the securing plate has fastening ends arranged thereon, and is provided with corresponding through holes and grooves for insertable connection with the connector body such that the signal terminals are pressed into the grooves so as to be soldered to wire core ends of the signal wires, the upper cover being disposed on an upper edge thereof to thereby provide stable signal transmission.

2. Description of the Prior Art

With the fast development of the information industry, use of a large amount of storage devices is becoming popular. The transmission and communication of data in the hardware requires the use of bus connectors. Conventionally, a bus connector is a piercing type, and has a structure which includes an insulating housing, and a plurality of equidistantly spaced-apart insert holes. The insert holes are provided for connection with signal terminals (the so-called pins). The upper end of the signal terminal is configured into an U-shaped clamping opening, and the signal terminals are disposed according to the plurality of insert holes formed in the insulating housing. The recessed type clamping opening is used to pierce and clamp the signal wire (the connection of the signal wire is similar to that in household telephone connection in which the wire head end of the signal wire does not have to be stripped of the plastic skin, and the insulative plastic skin of the signal wire is directly pierced by the clamping end to permit contact between metal wires). Since the signal wire of the bus connector is clamped by means of piercing, the metal and the signal terminal are in point contact, and since only the clamping points on the two sides serve as contacts, the stability of signal transmission is to be considered. Besides, since existing bus connectors are formed by using such a piercing method, without any breakthrough in terms of improvement for a relatively long time, there is a need for an improved structure.

### SUMMARY OF THE INVENTION

The primary object of the present invention is to provide a computer bus connector to improve upon the prior art. According to the invention, a connector body is insertably connected to a securing plate to secure signal terminals (pins). Such a method of insertably connecting the securing plate can effectively replace the conventional method of forming the piercing type bus connector. Wire core ends of signal wires and the pins are integrally coupled to provide a preferred plane contact, thereby providing better stability in signal transmission, reducing impedance and enhancing transmission efficiency.

To achieve the above object, the computer bus connector of the invention includes a connector body, a securing plate, a plurality of signal terminals (pins), a signal wire unit and an upper cover. The computer bus connector including the above components is different from the process of making the conventional piercing type bus connector in the application of tin solder. Signal terminals and signal wires are inserted and pressed into the securing plate, and the terminals and lead wires are integrally coupled by soldering so that signal is more stable during transmission, impedance is reduced, and transmission efficiency is enhanced.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic perspective view of a securing plate of the structure of the present invention;

FIGS. 2A, 2B and 2C respectively illustrate a top view, a front view and a side view of the securing plate of the structure of the present invention;

FIGS. 3, 4, 5 and 6 illustrate how to assemble the preferred embodiment of the structure of the present invention; and

FIG. 7 is a schematic perspective view of the preferred embodiment of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

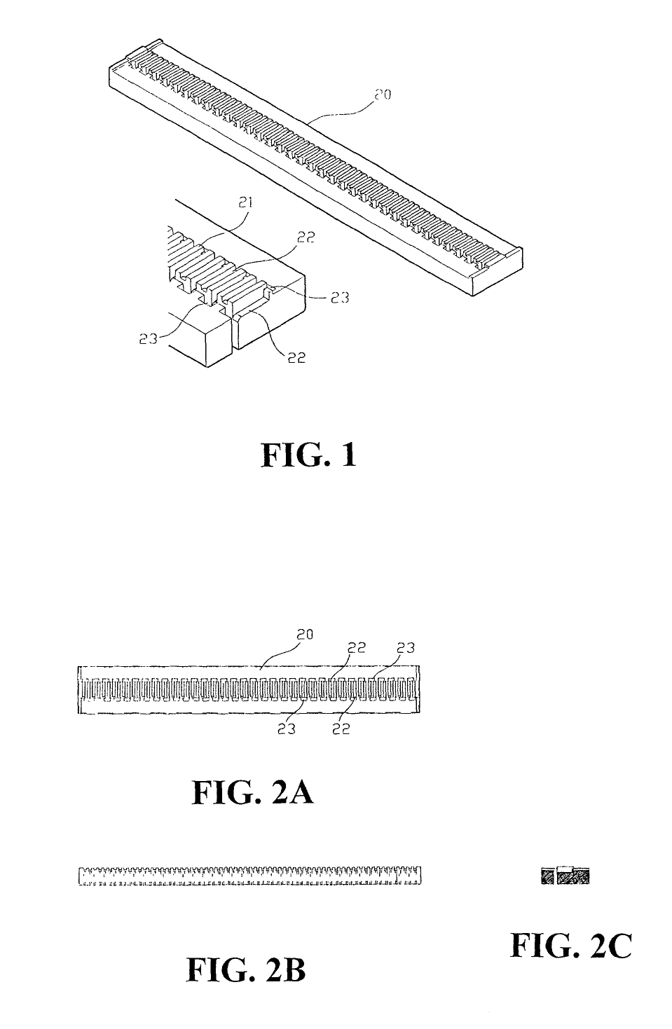

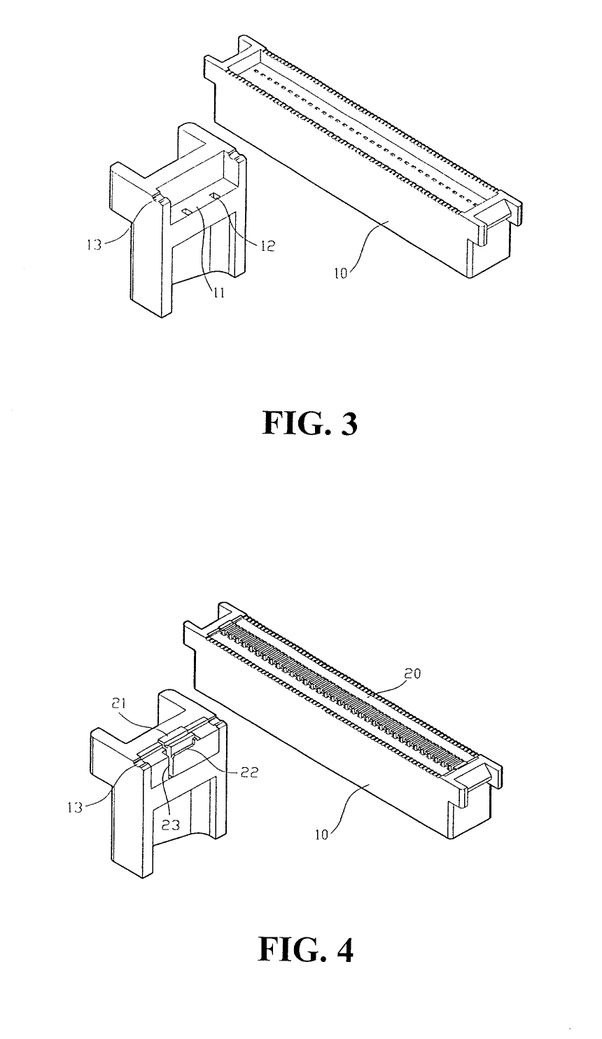

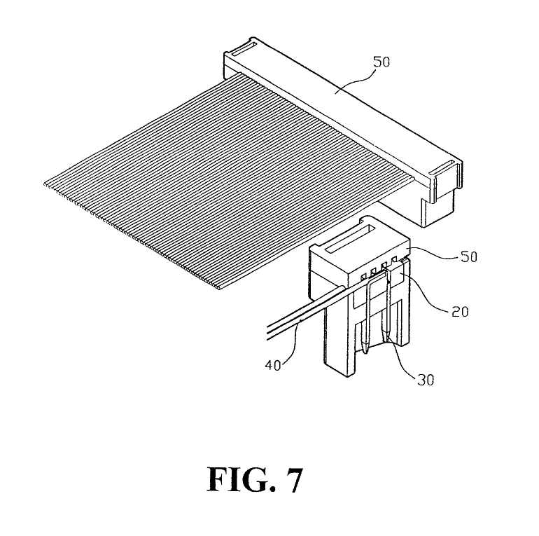

Referring to FIGS. 1 to 7, the preferred embodiment of a computer bus connector according the present invention includes a connector body 10, a securing plate 20, a plurality of signal terminals (pins), a signal wire unit 40 and an upper cover 50.

The connector body 10 (formed from insulating material) is provided with a depression 11 of a suitable depth for insertable connection with the securing plate 20. The depression 11 is provided with two arrays of equidistantly spaced insert holes 12 for insertion of signal terminals 30. Upper edges of two side plates of the body are provided with a plurality of curved recesses 13 for laying of signal wires 40 at the upper side and for laying of lead wires in two directions.

The securing plate 20 (insulating material) is integrally formed to correspond to the form of the depression 11 provided in the connector body 10 so that it can coupled tightly with the body. The securing plate has an array of fastening ends 21 arranged thereon, and is symmetrically provided with holes for receiving signal terminals 30 (pins) and grooves 22 for laying of signal wires 40 on both sides. Corner portions are configured to be inverted corners so that the bent pins on both sides can be firmly inserted into through holes 23 in the securing plate and insert holes 12 in connector body 10.

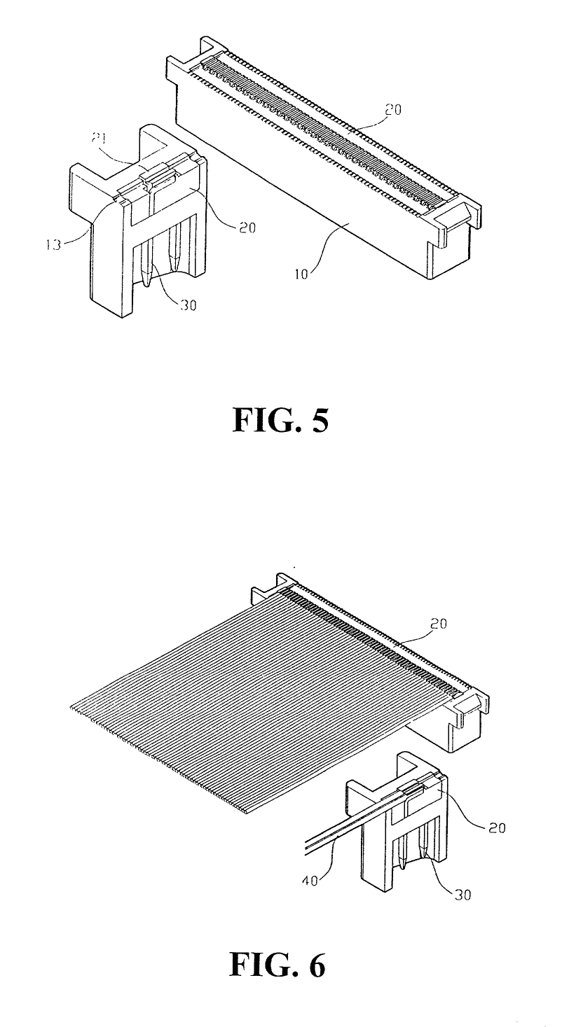

The preferred production process for the computer bus connector of the invention will be described hereinafter. Referring further to FIGS. 3 to 7, the securing plate 20 is pressed into the depression 11 in the connector body 10 (during coupling of the securing plate 20 and the body 10, the function of the securing plate is to secure signal terminals 30 so that short circuit will not occur between signal terminals, and the wire core can be disposed in the grooves 22 during soldering of signal wires 40 to facilitate production), and the signal terminals (pins) are inserted into the insert holes in the connector body, with the pins pressed into the grooves 22 in the securing plate. The signal wires 40 are soldered to the pins to couple therewith as a whole (outer coverings of wire heads at the front end of the bus is stripped and the wire cores are neatly arranged in the grooves in the securing plate, and the wire cores are soldered to the signal terminals integrally to achieve a plane contact so that the signals are more stable during transmission and the impedance can be lowered to enhance transmission efficiency). Finally, the upper cover 50 is put in place (the upper cover 50 is to protect junction between signal wires 30 and signal terminals 40 and to prevent exposure of the wire core so as not to result in short circuit).

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A computer bus connector, comprising a connector body, a securing plate, a plurality of signal terminals (pins), a signal wire unit and an upper cover, wherein said securing plate has fastening ends arranged thereon, and is provided with corresponding through holes and grooves for insertable connection with said connector body such that said signal terminals are pressed into said grooves so as to be soldered to wire core ends of said signal wires, said upper cover being disposed on an upper edge thereof to thereby provide stable signal transmission.
